(19) United States
(12) Patent Application Publication
(10) Pub. No.: US 2023/0122802 A1
(43) Pub. Date: Apr. 20, 2023

(54) BREATHING AIR CLEANING DEVICE

(71) Applicant: FRESENIUS MEDICAL CARE DEUTSCHLAND GMBH, Bad Homburg (DE)

(72) Inventors: Juergen HAECKER, Neu-Anspach (DE); Ralf MUELLER, Bad Homburg (DE); Andreas ROESE, Frankfurt (DE); Alexander HEIDE, Eppstein (DE); Markus KOEHLER, Oberursel (DE); Benedict GLASER, Schweinfurt (DE); Gerome NEWPORT FISCHER, Unstrut-Hainich (DE)

(73) Assignee: FRESENIUS MEDICAL CARE DEUTSCHLAND GMBH, Bad Homburg (DE)

(21) Appl. No.: 17/915,501

(22) PCT Filed: Apr. 7, 2021
(86) PCT No.: PCT/EP2021/059114

§ 371 Date: Sep. 29, 2022

(30) Foreign Application Priority Data
Apr. 9, 2020 (DE) 10 2020 110 110.4

(51) Int. Cl. A62B 7/10; A62B 18/02; A62B 23/02; A62B 9/02; A62B 18/10; A62B 18/00; B01D 63/02; B01D 63/04

(52) U.S. Cl. CPC A62B 7/10; A62B 9/02; A62B 18/006; A62B 18/10; A62B 18/025; A62B 23/02; B01D 63/02; B01D 63/046; B01D 2313/06; B01D 2313/10; B01D 2313/12; B01D 2313/13; B01D 2313/18

(57) ABSTRACT

The invention relates to a respiratory air purifier device. In order to provide an improved respiratory air purifier device which is able effectively to retain viruses, a respiratory air purifier device 101 is proposed for retention of viruses from respiratory air flowing through the device 101, the latter having an interface 110 designed such that it can be placed by a wearer sealingly onto at least one respiratory opening, a hollow-fibre dialyser 120 as a filter, and a connection piece 130 between the interface 110 and the dialyser 120, wherein interface 110, dialyser 120 and connection piece 130 are configured in such a way as to form an airtight fluid channel which fluidically connects the interface to either only the exterior of the hollow fibres X or only the interior of the hollow fibres I of the hollow-fibre dialyser 120, and wherein the purifier device 101 is designed in such a way that, in at least one flow direction E, A, each flow path pE, pA that runs completely through the purifier device extends through the pores of the hollow-fibre membranes, i.e. transversely with respect to the hollow-fibre membrane, of the hollow-fibre dialyser 120.

Doctors, nurses and other medical personnel who are in very close contact with highly infectious patients on a daily basis require special protection against infection.

Looking at it the other way round, doctors, nurses and other medical and hospital personnel belong to a group of people who are particularly often in contact with immunocompromised patients. It is therefore desirable to take particular care to prevent a member of this group of people becoming ill or infectious themselves, without realizing it, when managing patients. In the case of immunocompromised patients, a risk is also posed by infectious diseases that are otherwise fairly harmless.

Viruses are very small pathogens. They may for example be attached to small droplets of liquid or to fine dust particles and be spread in the ambient air over large areas as an aerosol.

Common filter systems such as masks or nonwovens have either no or only very limited retention rates for very small particles: known devices for purifying air for breathing, for example respiratory protection masks and mouth/nose protectors, have the problem that they are permeable to isolated viruses. This applies not just to simple mouth/nose protectors (also called surgical masks), as are often used in operating theatres and by dentists, but also to masks with a greater protective effect, for example according to EN 149 in class FFP-3. The protective effect usually stems from the fact that viruses, bacteria and other germs and pathogens are often contained in droplets that are much larger than viruses. These droplets remain attached to masks, and therefore the viruses contained in the droplets do not pass through the masks. Such a mask therefore protects a human wearer from pathogens within the droplets. However, when the droplets dry, and the biomaterial contained in them is swirled up, viruses are then present in the air, without being bound within a much larger droplet. The known filter masks do not effectively prevent the penetration of these viruses into the airways of a wearer. To be classed as FFP-3, it is necessary that the following protective effect (or better) is achieved: Protection from at least 99% of particles with a maximum size of 600 nm must be ensured. Even for filters used in professional ABC protective equipment, it is often only this requirement that is stipulated.

Known virions, i.e. virus particles outside cells, have a diameter of ca. 15 nm to 450 nm and are therefore considerably smaller than the reference particle for the standardized protective effect of respiratory protection masks.

Therefore, in environments with an atmosphere that is particularly hazardous to health, compressed air from cylinders is typically breathed, for example in hermetically sealed protective clothing with local positive pressure and with an air supply by means of compressed air cylinders or via a stationary supply and long hoses. Such solutions involve equipment that is very complex, large, heavy and not very mobile.

Wearing filter systems on the body or on the face always causes the wearer some inconvenience. The wearer’s field of vision is restricted, breathing can be made more difficult, putting on the protective clothing itself is awkward, and so on.

In short, there are no light-weight, inexpensive, ergonomic, wearable filter masks that are able reliably to filter viruses from the air.

It is therefore an object of the present invention to provide an improved respiratory air purifier device that is able effectively to retain viruses.

This object is achieved by a respiratory air purifier device with a hollow-fibre dialyser as an air filter according to Claim 1. Embodiments and developments of the inventive concept are the subject matter of dependent claims.

A respiratory air purifier device for retention of viruses from respiratory air flowing through the device has an interface designed such that it can be placed by a wearer sealingly onto at least one respiratory opening, a hollow-fibre dialyser as a filter, and a connection piece between the interface and the dialyser, such that an airtight fluid channel fluidically connects the interface to either only the exterior of the hollow fibres or only the interior of the hollow fibres of the hollow-fibre dialyser, such that each flow path that runs completely through the purifier device extends through the pores of the hollow-fibre membranes, i.e. transversely with respect to the hollow-fibre membrane.

Known hollow-fibre dialysers for haemodialysis have a pore size of 2 nm to 12 nm on the filter membrane, the wall of the hollow fibre. The pores are therefore smaller than the smallest known viruses. As air flows through the filter membrane, effectively all viruses are thus retained, since they do not pass through the pores. Moreover, known hollow-fibre dialysers in a compact and light-weight housing have a large membrane surface of 0.5 - 2.5 m². That is a much larger filter surface than in known respiratory protection masks. A further advantage lies in the standardized ports of the dialysers, which ensure interoperability of various manufacturers. Dialysers are available almost everywhere in the world. Since they are produced in large numbers and are approved as a medical product, they are reliably of high quality. Suitable for the respiratory air purifier device are for example hollow-fibre dialysers of the types FX_classix, FX_cordiax, FX_cordiaxHDF, FX, Optiflux, Hemoflow F High Flux and Hemoflow F HPS manufactured by Fresenius Medical Care. However, common hollow-fibre dialysers from other manufacturers may also be suitable.

It has surprisingly been found that the flow resistance of a hollow-fibre dialyser for haemodialysis transverse to the membrane, i.e. through the pores of the hollow-fibre membrane, in relation to respiratory air is low enough to allow a healthy adult to breathe through a dialyser transversely with respect to the membrane even for example without electrical assisting devices such as a fan.

In a simple embodiment, the respiratory air purifier device claimed here has the following component parts: An interface designed such that a human can put on and wear the device, a hollow-fibre dialyser as a filter, and a connection piece between the interface and the dialyser, designed such that an airtight connection is created between the interface and a filter side of the filter. In the case of a hollow-fibre dialyser, one filter side is the exterior of the hollow fibres, and the interior of the hollow fibres is the second filter side. The hollow fibres of such a dialyser have microscopically small openings. Respiratory air is able to pass through these openings, but not pathogens such as viruses. Known dialysers are designed as a cylindrical bundle of a multiplicity of hollow fibres, which are arranged in a likewise cylindrical housing. To provide fixing and sealing, a sealing compound is arranged between the fibres at the axial ends of the cylindrical housing, i.e. at the two circular faces that axially delimit the dialyser. The two axial ends of the cylindrical housing could be referred to as the cylinder top and cylinder bottom. The sealing compound may be for instance a casting compound. However, the interiors of the fibres are free. Thus, for the entire bundle of hollow fibres, the interior is separated from the exterior.

A central aspect of the invention is to use a hollow-fibre dialysis filter, or hollow-fibre dialyser, as a filter in a respiratory air purifier device. The further elements of the respiratory air purifier device must in this case be designed such that a system of fluid paths, also called flow paths, is so defined that all fluid paths of the system in one direction of flow through the respiratory air purifier device run through the filter in such a way that they pass from one filter side to the other filter side. In the case of a hollow-fibre dialyser, wherein the hollow fibres have a membrane with pores, this means that these fluid paths extend transversely with respect to the hollow-fibre membranes, i.e. extend through the pores of the porous membrane of the hollow fibres. On passage through the pores, nanoparticles such as viruses are retained. Larger particles, for example bacteria or archaea, are also retained. However, air gas molecules will flow through the pores unimpeded. In this way, respiratory air passing through the pores is purified, and pathogens are retained. In addition, spores, pollen, nanoparticles, fine dust and other airborne substances hazardous to health, e.g. asbestos fibres or radioactive dust (“fallout”), are also retained.

On a housing of commercially available hollow-fibre dialysers, there are often at least four port options: Two ports permit fluidic connection to the interior of the hollow fibres, and two other ports permit fluidic connection to the exterior of the fibres. Typically, at the cylinder top and at the cylinder bottom, there is in each case one port permitting fluidic connection to the interior of the hollow fibres and one port permitting fluidic connection to the exterior of the hollow fibres. In many dialysis applications, dialysate is flushed through the exterior, and the blood of a patient who is to be treated is flushed through the interior. The ports fluidically connected to the exterior are often arranged laterally on the housing, and the ports fluidically connected to the interior are often arranged axially.

For a respiratory air purifier device according to the invention, it is necessary that a port for incoming respiratory air or outgoing respiratory air is fluidically connected to only either the exterior or the interior of the hollow fibres. For this purpose, for example both ports that are fluidically connected to the exterior of the hollow fibres can be connected in parallel.

A respiratory bubble is understood as a device which encloses the head of a wearer in a light, flexible, bubble-shaped structure, for example a plastic film, resulting in an airtight separation of the respiratory space of the wearer from the ambient air. A respiratory helmet is understood as a similar arrangement which, instead of a light, flexible structure, has a stable structure like a closed helmet.

According to one aspect, a respiratory air purifier device according to the invention is designed such that the interior of the hollow fibres of one or more hollow-fibre dialysers is fluidically connected to the interface for covering at least one respiratory opening of a human wearer. The exterior of the hollow fibres of said dialyser or dialysers is fluidically connected to the ambient air.

According to one aspect, a respiratory air purifier device according to the invention has a supporting structure for holding the hollow-fibre dialyser or dialysers. This ensures that the dialysers can be fitted in place particularly safely and comfortably. In one development, a carrying aid for the dialyser or dialysers is designed such that the weight does not exert a load on the facial region connected to the interface of the device when it is being worn, but instead the interface has a flexible component, for example a flexible hose, and the dialyser or dialysers can be carried more comfortably, for example on the back, at the side, on a belt or on the chest. A device according to the invention can thus be worn over quite a long period of time.

According to one aspect, a plurality of dialysers are connected in parallel in one flow path of the respiratory air purifier device. The membrane surface areas of the dialysers thus effectively add together, and the flow resistance through the device is particularly advantageously reduced. Thus, two, three, four or more dialysers can be connected in parallel. For larger, stationary arrangements, it is also conceivable for a hundred, thousand or more dialysers to be connected in parallel.

According to one aspect, a respiratory air purifier device is designed such that the control of different flow paths in different flow directions is effected via two check valves arranged in the connection piece. The check valves are preferably such that their opening pressures are very low (< 2 mbar).

According to one aspect, a respiratory air purifier device is designed such that air flowing in has to flow transversely with respect to the membrane. In this way, viruses from the ambient air are kept away from a wearer. A wearer is thus protected against viruses even when dealing with highly infectious material, living things or other people.

According to one aspect, a respiratory air purifier device is designed such that air flowing out has to flow transversely with respect to the membrane and is thus filtered. In this way, any viruses possibly present in the respiratory air of a wearer can be retained. It is thus possible, without further testing, for a person wearing the device to come into proximity for example with an immunocompromised or immunosuppressed or deficient person, e.g. in the case of hospital personnel. If an infected person is wearing such a device, there is then no longer a risk of infection, for example with viruses, from the air exhaled by said person. Thus, despite being ill, an infected person could for example visit immunocompromised persons without posing a risk of infection.

According to one aspect, a respiratory air purifier device is designed such that both air flowing in and air flowing out has to flow transversely with respect to the membrane. Thus, both the air inhaled by a wearer and the air exhaled by a wearer is advantageously filtered. The wearer is protected against viruses from the ambient air, and the environment of the wearer is protected against viruses in the respiratory air of the wearer.

An illustrative embodiment of the respiratory air purifier device is designed to purify air in both directions. This embodiment has two check valves, which are arranged such that a first system of fluid paths is established for the inflow and a second system of fluid paths is established for the outflow. Here, no inward path is identical to any outward path. A whole system of paths is created in each case, since a hollow-fibre dialyser on the one hand has a multiplicity of hollow fibres and, on the other hand, each hollow fibre has a multiplicity of openings. In this embodiment, three hollow-fibre dialysers connected in parallel are arranged to filter the incoming air. Moreover, a further four hollow-fibre dialysers connected in parallel are arranged to filter the outgoing air. In this illustrative embodiment, the interface can preferably be configured as a full-face mask.

In the context of the application, “inflow” or “inflow direction” means the flow that passes through the respiratory air purifier device according to the invention to the interface, i.e. it denotes the direction of flow that is present when a wearer inhales. This direction of flow corresponds to the case of air flowing out of the device through the interface. Conversely, “outflow” or “outflow direction” means the flow that passes through the respiratory air purifier device according to the invention from the interface. The directions of flow are thus to be understood with reference to a wearer. Inflow corresponds to inhalation, and outflow corresponds to exhalation. Since air flows through the respiratory air purifier device according to the invention in both cases, a definition based on the perspective of a wearer is approriate.

In an illustrative compact embodiment of the respiratory air purifier device for purifying only the inflowing air, the interface can be designed, for example, as a mouthpiece, as in the case of a snorkel. The embodiment also has a check valve of the kind known from a snorkel, for delivering the exhaled air directly to the environment. This embodiment preferably has two dialysers connected in parallel into the incoming air channel. This embodiment can be regarded as a variant for self-protection.

An illustrative embodiment of the respiratory air purifier device is designed as a device purely for protecting others and has, as a wearer interface, a mask which completely covers the mouth and nose, for instance like a paint sprayer’s mask. The mask has a check valve which is arranged such that only outflowing air flows through the dialysers. Here, for example, three dialysers are connected in parallel.

According to one aspect, the respiratory air purifier device has an electric fan which assists the flow of air along a fluid channel extending through the pores of the hollow-fibre membrane. In this way, the respiratory resistance for a wearer is particularly advantageously reduced. An assisting fan is conceivable for the inflow of air, i.e. supporting the inhalation performed by a wearer, for the outflow of air, i.e. supporting the exhalation performed by a wearer, or for both directions. In a development of this aspect, the electric fan has an electric accumulator for supplying energy. In one development, the device or the fan is equipped with an interface for inductive electrical charging, for example Qi charging. In a further development of this aspect, the respiratory air purifier device is of modular construction. The device can in this case be divided into modular parts. One modular part can, for example, comprise all the electrical components (for example the electric fan, the electric accumulator and a charging interface). This affords the advantage that the modules can be easily separated from one another. The electric module can be configured such that it does not come into contact with the interface, and thus also not with a wearer. In this case, the electric module can be used by different users without causing hygiene risks. On the other hand, when the battery is depleted, a user can easily detach the electric module and replace it with a module with a full battery, without removing the interface, for example a full mask or a helmet, and is thus exposed to less risk. Moreover, the interface part can be designed as a module which is not only separable from the electric module, but also from the filter module, which has the dialyser or dialysers. It is thus possible to provide separate hygiene management for the interface and the filter. A further advantage is afforded for example in a quarantine ward of a hospital: Here, the electric module can be used by multiple wearers, without compromising on hygiene. By virtue of the multiple use and, for example, direct storage at charging stations, fewer individual modules need to be procured. An electric fan can provide assistance in overcoming the flow resistances through a dialyser. According to a further aspect, a fan with a battery for electrical supply can be fastened, for example, to the user’s belt. The fan and the dialyser can be separated from the interface of the respiratory air purifier device, and the battery of the fan can be recharged at a charging station. At this station, condensate can also be removed during the charging process. For this purpose, open ends, which are exposed at the time of the separation, are attached to a bypass piece. While the battery is being charged, the fan can blow ambient air through the dialyser or dialysers of the purifier device and thereby remove condensate. Thus, the part of the purifier device without the interface can be used by different wearers with different interfaces. This advantageously permits operation with less friction and with greater flexibility.

In variants having a plurality of dialysers, the latter can be arranged in parallel alongside one another, in parallel in a triangular arrangement, in a star-shaped arrangement or as a square, or they can be arranged offset from one another on a radius of a circle.

According to one aspect, in order to reduce formation of condensate in the filter caused by humidity in exhaled air, thermal insulation can be provided, or the dialysers can be applied close to the body.

According to one aspect, the connection piece of the respiratory air purifier device can be designed as a transition piece with corrugated bellows, spring bellows or another flexible section such as a hose or tube between the interface and the dialyser, e.g. made of plastic or an elastomer. In this way, a flexible spatial separation of the interface and the dialyser is permitted, such that, for example, a wearer can wear the dialysers on his head, directly below the interface, or on his front or back, or like a shoulder bag at his side.

The interface of the respiratory air purifier device can be designed such that, when it is being worn, it can cover the wearer’s mouth and nose (mouth/nose mask) and can otherwise rest sealingly on the face. Alternatively, the interface can be designed purely as a mouthpiece, for instance as in the case of a snorkel for diving. Alternatively, the interface can be designed purely as a nose mask, for example as known for non-invasive CPAP ventilation in the case of sleep apnoea. However, a design of the interface as used in the case of invasive CPAP is also conceivable. Alternatively, the interface can sealingly cover a larger region of the face, as known for example from diving masks which, in addition to covering the nose and mouth, can also cover the region of the eyes.

According to one aspect, an alternative purifier device can be used for a glove box, a clean room, a quarantine room or a special ward room for immunocompromised or immunosuppressed persons. Naturally, such a variant is not necessarily wearable. The interface of the device is then also not designed for covering a respiratory opening of a person, but instead for attachment to a room, to a room ventilation unit or to a glove box. In the case of the glove box, for instance for handling infectious or pathogenic materials, or indeed particularly without exposure to these, the device would of course not be wearable, but it would be at least mobile. In the case of purifying air for a clean room, a quarantine room or the ward room for immunosuppressed persons, the device can be stationary. In these mobile or stationary variants, the incoming air and/or the discharged air can be purified in each case.

According to one aspect, a variant of a respiratory air purifier device has a hermetically sealed helmet as an interface, which is attached by the connection piece to one or more dialysers but to only one controlled fan. The fan can deliver air in both directions. A control ensures that, under the hood, there is always a predetermined slight overpressure in relation to the ambient air pressure. When the person wearing this device inhales during the operation of the device when it is being worn, the fan runs in the forward direction and assists the inhalation via the inflow dialyser or dialysers. When the wearer exhales, the fan delivers air in the other direction into the environment, either via the same dialyser or dialysers or else via a separate fluid path controlled by check valves and via one or more second dialysers.

According to one aspect, the respiratory air purifier device can be designed such that the dialysers therein are connected releasably. Dialysers can be reused in this device over a long period of time. Waste is thus avoided, and the consumption of resources is reduced. For reuse in the respiratory air purifier device, dialysers can be cleaned and/or disinfected in an alcohol bath, in an autoclave, by means of hot steam, by humid or dry heat over a defined period of time (e.g. 120 or 150° C. for one hour or 30 minutes), or by having hot air blown at them, e.g. at 60° C. for 2 hours.

### BRIEF DESCRIPTION OF THE DRAWING

Embodiments of the device are described below with reference to the drawing, in which:

FIG. 1 shows an embodiment of the respiratory air purifier device according to the invention, with a mouth/nose mask as an interface and with optional check valves,

FIG. 2 shows the embodiment according to the invention from FIG. 1, wherein a flow path in the inflow direction and a flow path in the outflow direction are additionally shown,

FIG. 3 shows an embodiment of the respiratory air purifier device according to the invention, with a mouth/nose mask as an interface and with a particularly compact connection piece,

FIG. 4 shows a dialyser prepared for a respiratory air purifier device according to the invention,

FIG. 5 shows an example of an arrangement of a connection piece, check valves and an interface in the context of the invention,

FIGS. 6a and 6b show two views of an example of an arrangement of a plurality of dialysers and an example of a connection piece, for the arrangement of the dialysers, as a component part of a respiratory air purifier device according to the invention,

FIGS. 7a and 7b show two views of an example of an arrangement of a plurality of dialysers and an example of a connection piece, for the arrangement of the dialysers, as a component part of a respiratory air purifier device according to the invention,

FIG. 8 shows an illustrative embodiment of a respiratory air purifier device according to the invention with an electric fan, in a variant in which the fan is arranged directly on a dialyser,

FIG. 9 shows an illustrative embodiment of a respiratory air purifier device according to the invention with an electric fan, in a variant in which a distribution piece is arranged between the fan and a plurality of dialysers,

FIG. 10 shows an illustrative embodiment of a respiratory air purifier device according to the invention with an electric fan, in a variant in which the fan is arranged on a dialyser but spaced apart from the latter with a transition piece,

FIGS. 11a and 11b show two views of a variant of the respiratory air purifier device according to the invention with an electric fan, with a respiratory hood as an interface and with separate dialysers in the inflow direction and the outflow direction, in which variant the fan is arranged to assist the inflow of air,

FIG. 12 shows a device according to the invention for the cleaning, sterilizing or disinfecting of dialysers used in respiratory air purifier devices according to the invention.

In the figures, identical or similar elements may be referred to by the same reference signs.

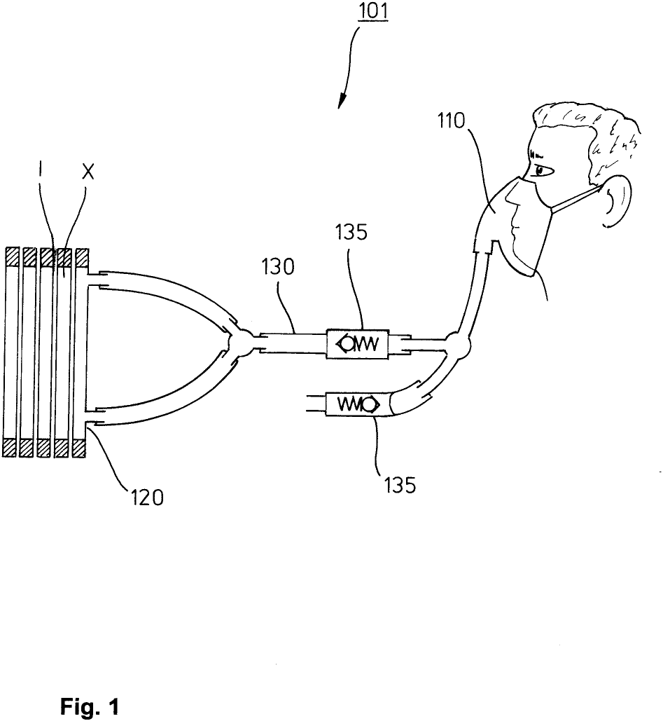

FIG. 1 shows an embodiment of the respiratory air purifier device 101 according to the invention, with a mouth/nose mask as an interface 110 and with a connection piece 130, having optional check valves 135, between the interface 110 and the dialyser 120. The optional check valves can also be omitted. In the arrangement shown, the check valves 135 and further elements of the connection piece are arranged such that an airtight fluid channel is formed from the exterior X of the hollow fibres of the dialyser 120 to the interface 110. At the ends of the hollow fibres, a sealing compound seals off the exterior X of the hollow fibres of the dialyser 120 from ambient air (shown by hatching).

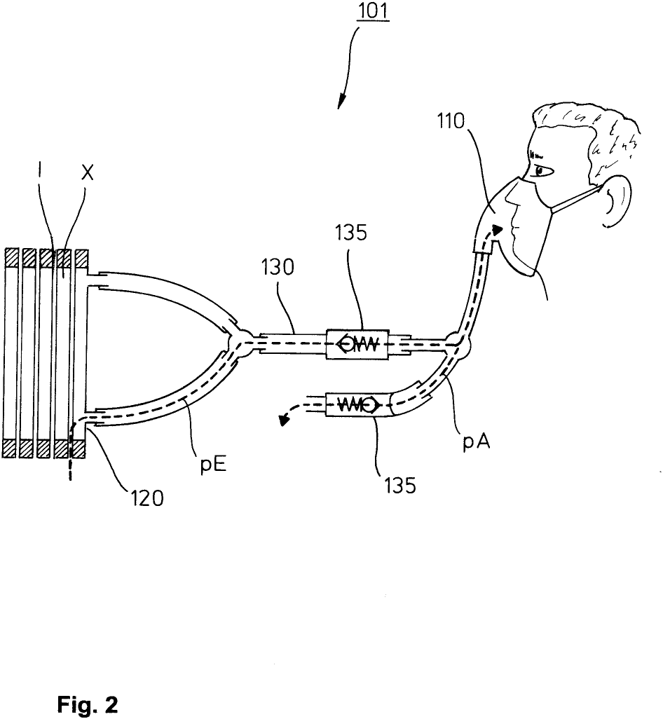

FIG. 2 shows the embodiment according to the invention from FIG. 1, wherein a flow path pE in the inflow direction dE and a flow path pA in the outflow direction dA are additionally shown. The embodiment of the respiratory air purifier device according to the invention is configured such that airtight fluid channels are created by interface 110, dialyser 120 and connection piece 130 such that resulting flow paths pE, pA are obtained. Flow path pE lies in inflow direction dE. When the wearer inhales through the respiratory air purifier device 101, ambient air will flow through the axial ends (which are open in the illustrative embodiment) of the dialyser 120 into the interiors I of the hollow fibres, through the pores of the membrane into the exterior X of the hollow fibres, and through the optional hoses, tubes, Y-pieces or nozzles of the connection piece 130, through an optional inlet check valve 135 to the interface 110, and then into a respiratory opening of the wearer. The second check valve 135 is arranged such that it opens when air flows through the device in the direction of exhalation of a wearer (flow path pA in outflow direction dA). This is the outflow direction. This means that air flows from the interface 110 into the device. In this case, the check valve 135 shown further above in FIGS. 1 and 2 remains opened, and the check valve 135 shown further below opens. Air can thus flow out of the device without passing through the dialyser 120 again. The airtight fluid channel created in the outflow direction by the device thus generates flow paths pA which do not run through the dialyser 120. In the embodiment of the respiratory air purifier device 101 according to the invention shown, its component parts are thus configured for filtering air when the wearer inhales. Alternatively, in an embodiment not shown, it is possible that only the air that the wearer exhales is filtered, if, in relation to the embodiment shown in FIGS. 1 and 2, the orientation of the check valves 135 is simply changed around. In this way, the airtight fluid channels of the device run in reverse, such that each flow path pA runs through the dialyser 120 during the outflow. Alternatively, a further dialyser 120, e.g. also with a Y-piece, can also be arranged at the branch of the connection piece 130 shown further below in FIGS. 1 and 2, such that in both directions, i.e. inflow direction dE and outflow direction dA, all flow paths pE, pA extend through the pores of the hollow-fibre membranes of a dialyser and are thus filtered of viruses. Optionally, the check valves 135 can also be omitted in all three variants.

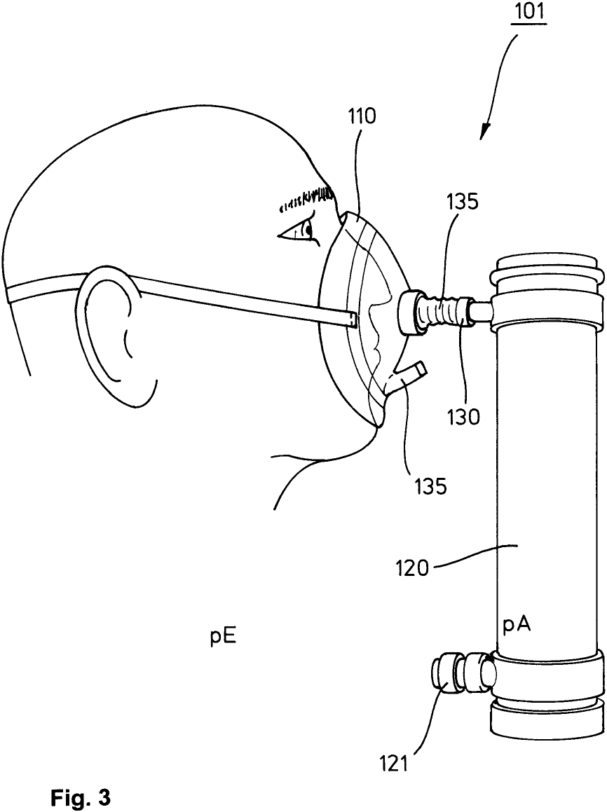

FIG. 3 shows an embodiment of the respiratory air purifier device 101 according to the invention, with a mouth/nose mask as interface 110 and with a particularly compact connection piece 130, which connects interface 110 and dialyser 120 almost directly. Here, it is possible for a fluid channel to be formed in the device in such a way that, both in inflow direction dE and outflow direction dA, all flow paths pE, pA run through the dialyser 120. A port 121 on the dialyser 120, on the exterior X of the hollow fibres, is closed in an airtight manner with a stopper, and the interior I of the hollow fibres is connected to the ambient air. The interface is connected in an airtight manner to the interior I of the hollow fibres. Optionally, one or two check valves 135 can be arranged on the device 101 and can be configured such that each flow path pE, pA runs through the dialyser 120 only in either inflow direction dE or outflow direction dA.

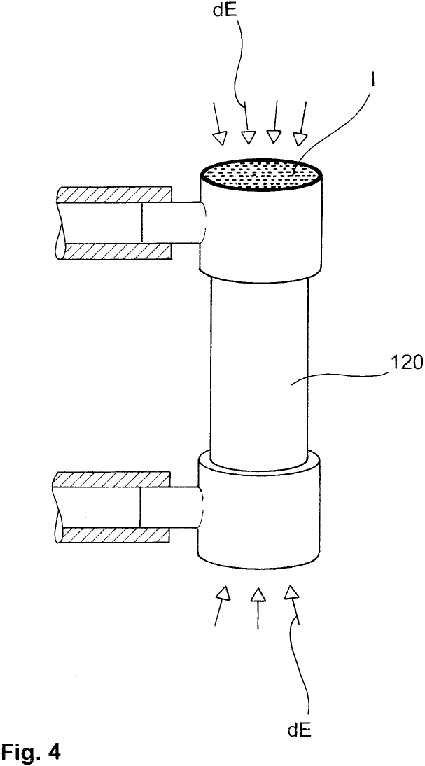

FIG. 4 shows a dialyser 120 prepared for a respiratory air purifier device 101 according to the invention, in which the axial end caps often to be found on dialysers, at the cylinder top and cylinder bottom of the housing, have been removed and the fibres exposed. Alternative embodiments can use dialysers that have other end caps or shapes. For example, the FX dialysers manufactured by Fresenius Medical Care also have ports which are connected to the interior I of the hollow fibres and which extend radially with respect to the cylindrical housing. It is shown, by way of example, how ambient air flows in inflow direction dE into the interiors I of the hollow fibres.

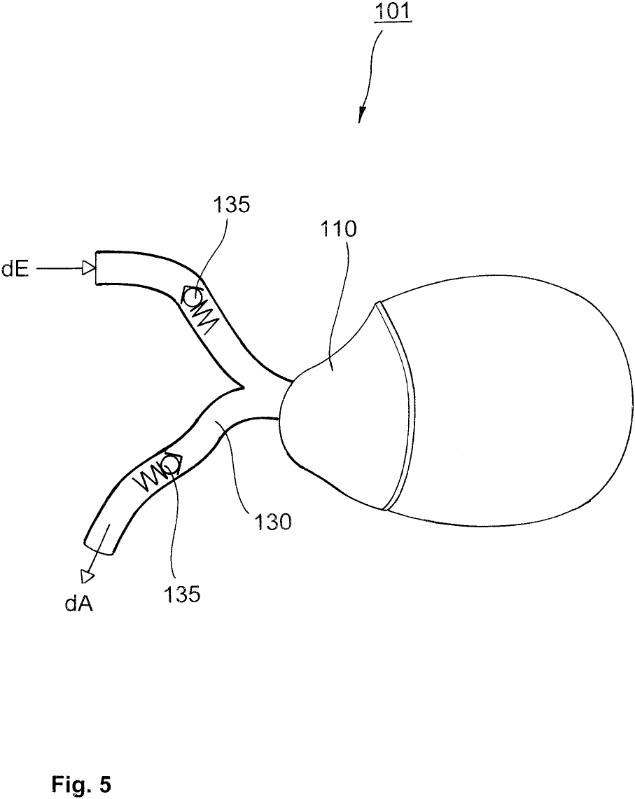

FIG. 5 shows an example of an arrangement of a connection piece 130, check valves 135 and an interface 110 of a respiratory air purifier device 101 in the context of the invention. It is shown here how optional check valves 135 are oriented and how the inflow direction dE and outflow direction dA thus arise.

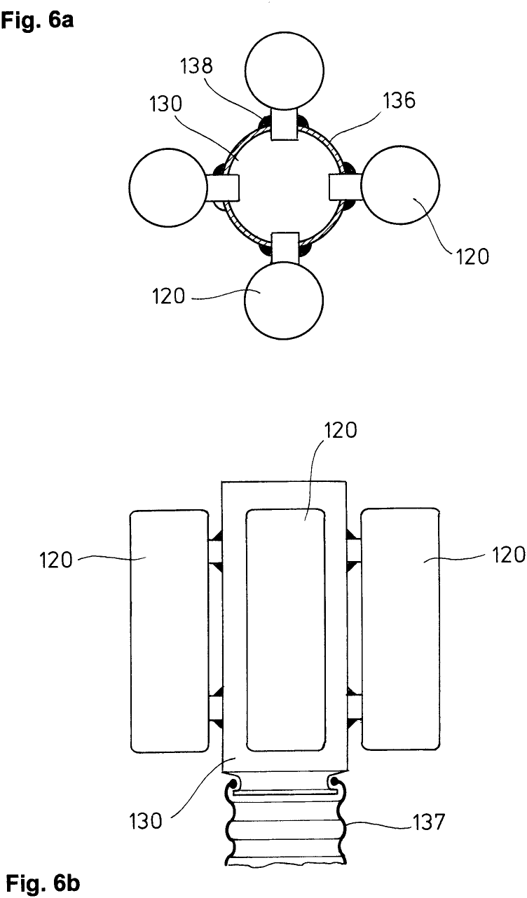

FIG. 6 shows two views 6a and 6b of an example of an arrangement of a plurality of dialysers 120 (here, for example, four or eight) and an example of a connection piece 130, for the arrangement of the dialysers 120, as a component part of a respiratory air purifier device 101 according to the invention. Here, 6a shows a plan view and 6b a side view of the same embodiment. The dialysers are connected in parallel with respect to the flow paths pE, pA, as a result of which the flow resistance is particularly advantageously reduced. The figure shows an example of how elements of the connection piece 130 can be designed. Thus, the connection piece may have a tube portion 136. The latter can be produced additively, for example by 3D printing. Moreover, the connection piece can have a flexible hose 137, for example a corrugated hose of the kind often used in vacuum cleaners. Adhesive 138, for example hotmelt adhesive, can be applied in order to seal the transition between nozzles on the housing of the dialysers 120.

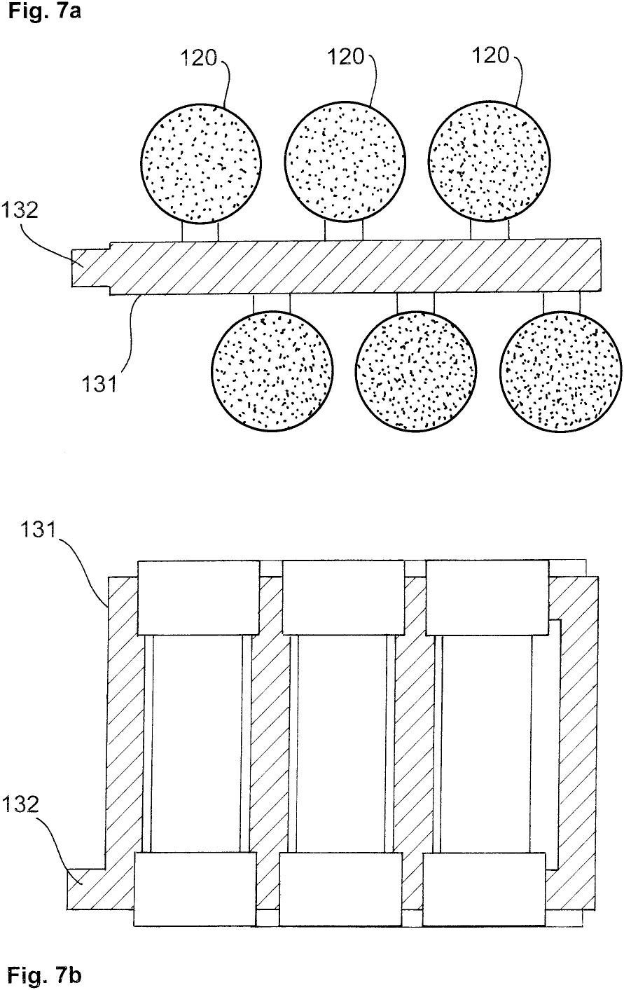

FIG. 7 shows two views 7a and 7b of an example of an arrangement of a plurality of dialysers 120 and an example of a connection piece 130, for the arrangement of the dialysers 120, as a component part of a respiratory air purifier device 101 according to the invention. Here, 7a shows a plan view of the same arrangement of which 7b shows a side view. Here, the connection piece 130 has a supporting structure 131, which can be designed as a hollow channel and with an attachment nozzle 132. In the variant shown, six dialysers 120 are shown. These can be connected at one end or at both ends to the supporting structure. Depending on the design of the supporting structure, airtight fluid channels are created such that all six dialysers 120 can be switched into inflow paths pE and/or outflow paths pA of a respiratory air purifier device 101 according to the invention, or some of the dialysers are switched only either into the inflow path pE or the outflow path pA in any desired distribution. For example, all inflow paths run through two dialysers, and all outflow paths run through four other dialysers. Or the distribution can be three to three. A similar structure is also conceivable for other numbers of dialysers, for example for 4, 5, 8 or 10 dialysers.

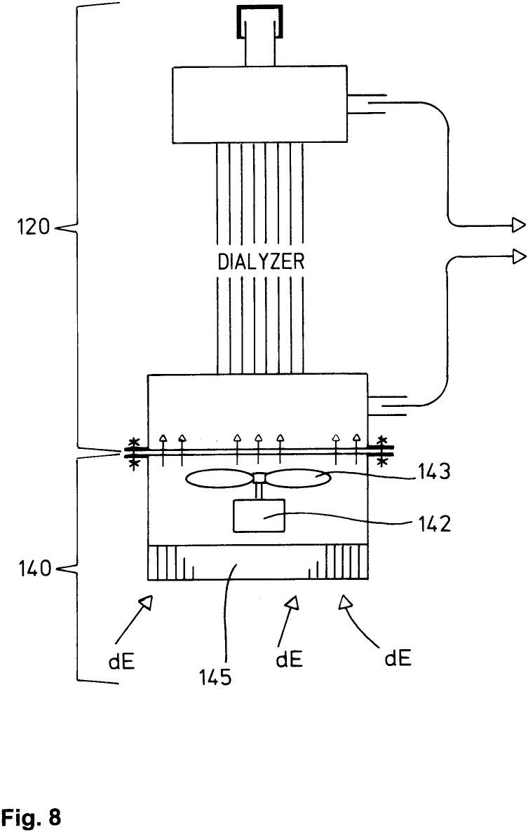

FIG. 8 shows an illustrative embodiment of a respiratory air purifier device 101 according to the invention with an electric fan 140, in a variant in which the fan 140 is arranged directly on a dialyser 120 and assists the air flow in inflow direction dE. In this way, the flow resistance along inflow paths pE is particularly advantageously reduced, and it is thus made easier for a wearer to inhale. This advantage applies analogously to an arrangement of a fan such that it suctions ambient air (not shown) at an outlet region of a dialyser 120 through which air flows in outflow direction dA, thus reducing the resistance in this direction, as a result of which it is made easier for a wearer to exhale. The electric fan 140 has an electric battery 145, an electric motor 142 and a fan rotor 143, e.g. a propeller.

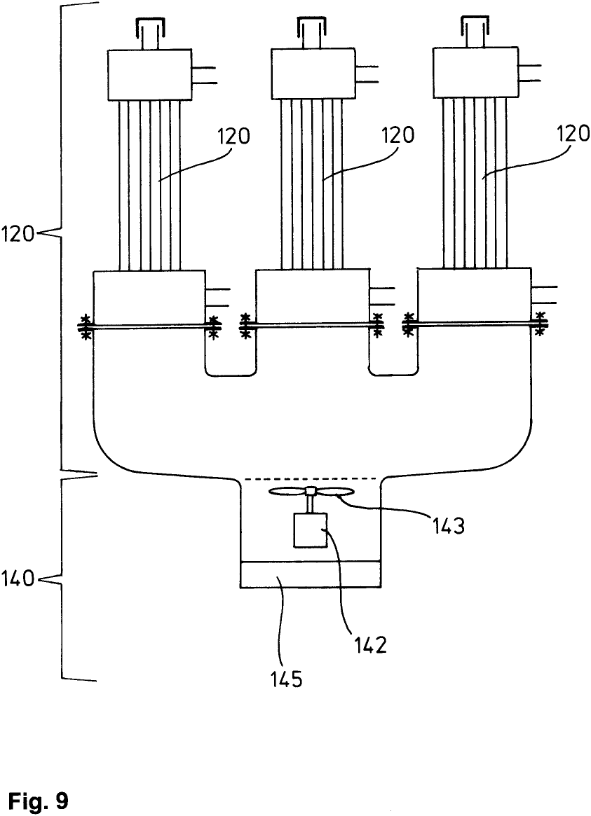

FIG. 9 shows an illustrative embodiment of a respiratory air purifier device 101 according to the invention with an electric fan 140, in a variant in which a distribution piece is arranged between the fan 140 and a plurality of dialysers 120. This affords the combined advantages of a plurality of dialysers and an electric fan, as explained above for the device 101 according to the invention.

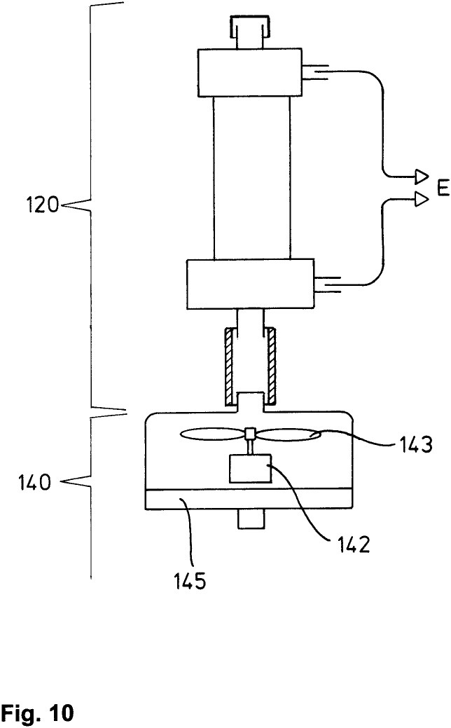

FIG. 10 shows an illustrative embodiment of a respiratory air purifier device 101 according to the invention with an electric fan 140, in a variant in which the fan 140 is arranged on a dialyser 120 but spaced apart from the latter with a transition piece. Compared to the embodiment from FIG. 8, this affords the advantage that the fan 140 can be mounted flexibly.

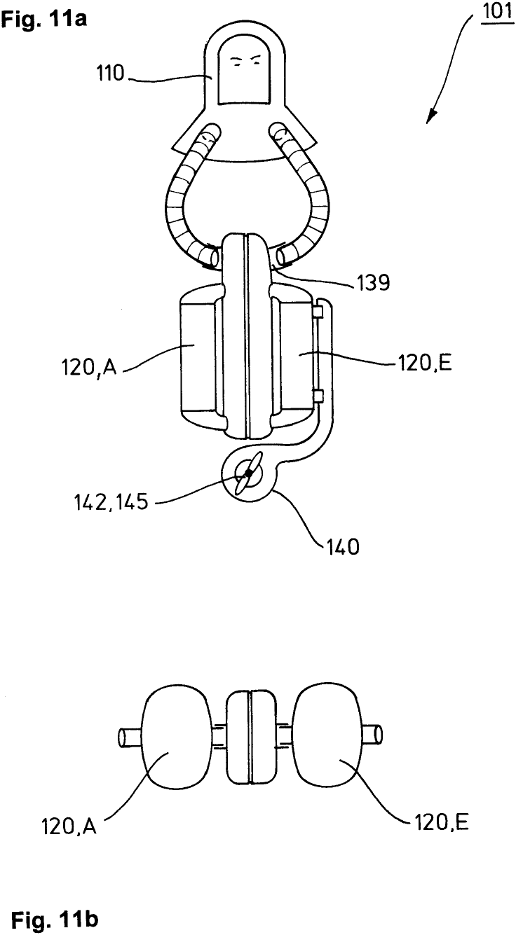

FIG. 11 shows two views 11a and 11b of a variant of the respiratory air purifier device 101 according to the invention with an electric fan 140, with a respiratory hood as an interface 110 and with separate dialysers 120 arranged in inflow direction dE and outflow direction dA, in which variant the fan 140 is arranged to assist the inflow of air. Here, 11b shows a detail of the device 101 from 11a in a plan view, while 11a shows the whole device in a front view. In addition to the respiratory hood, the connection piece 110 also has flexible hoses, which are fitted releasably onto a coupling 139 of a rigid supporting structure, which is also an element of the connection piece. A variant with a respiratory hood advantageously provides enhanced protection not only against infection but also against contamination and is, for example, expedient in conjunction with protective clothing for the whole body or for a large part of the body of a wearer.

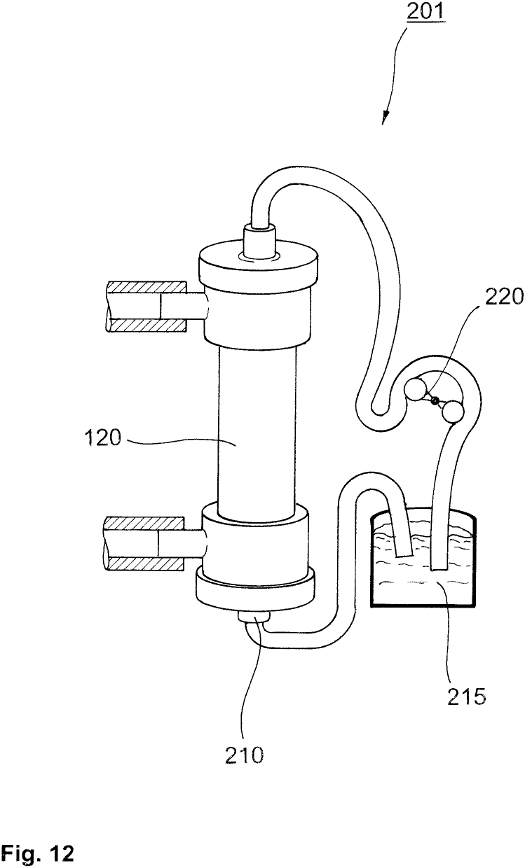

FIG. 12 shows an illustrative embodiment of a device according to the invention for the cleaning, sterilizing or disinfecting of dialysers used in respiratory air purifier devices according to the invention. A disinfectant 215 can be present in liquid form (e.g. alcohol) or gaseous form (e.g. hot steam). A pump 220, here shown as a roller pump, can be provided to circulate disinfectant. Attachment nozzles 210 for attachment to a dialyser 120 can be provided. A particular advantage of disinfection is that it allows dialysers to be reused for purifying respiratory air.

1. A respiratory air purifier device for retention of viruses from respiratory air flowing through the device, comprising
a. an interface designed such that it can be placed by a wearer sealingly onto at least one respiratory opening,
b. a hollow-fibre dialyser as a filter,
c. a connection piece between the interface and the dialyser,
wherein interface, dialyser and connection piece are configured in such a way as to form an airtight fluid channel which fluidically connects the interface to either only the exterior of the hollow fibres or only the interior of the hollow fibres of the hollow-fibre dialyser (120), and wherein the purifier device is designed in such a way that, in at least one flow direction , each flow path that runs completely through the purifier device extends through the pores of the hollow-fibre membranes, i.e. transversely with respect to the hollow-fibre membrane, of the hollow-fibre dialyser (120).

2. The device according to claim 1, wherein the interface is a mouthpiece, a mouth/nose mask, a nose mask, a mouth/nose/eye mask, a breathing safety tube, a respiratory helmet or a respiratory bubble.

3. The device according to claim 1, having a check valve which is arranged such that it opens in inflow direction into the device and all flow paths of the outflow run through the hollow-fibre dialyser or dialysers, or such that it opens in outflow direction out of the device and all flow paths of the inflow direction run through the hollow-fibre dialyser or dialysers.

4. The device according to claim 1, having at least two check valves or a three-way valve, which are arranged such that the inflow paths fixed in inflow direction by the valves are determined by a different fluid channel of the purifier device than for the outflow paths in outflow direction, and such that air can flow through the dialyser only in one flow direction.

5. The device according to claim 4, wherein the check valves are arranged such that a fluid channel is configured such that each flow path that runs completely through the purifier device extends either only in inflow direction or only in outflow direction through the hollow-fibre membranes of the dialyser .

6. The device according to claim 4, having at least two dialysers, wherein the check valves and the dialysers are arranged such that a first fluid channel, and the flow paths in inflow direction, runs only through the first dialyser or dialysers, and such that a second fluid channel, and the flow paths in outflow direction, runs only through one or more second dialysers.

7. The device according to claim 1, wherein a plurality of dialysers are connected in parallel into one or both flow paths , such that the surface areas of the membrane surfaces that are to be passed across in one or both flow paths add together.

8. The device according to claim 1, additionally having a supporting structure for holding the dialyser or dialysers in a defined position relative to the interface.

9. The device according to claim 1, additionally having an electric fan, which is configured to assist an air flow in inflow direction or in outflow direction into or out of the device.

10. The device according to claim 1, configured such that, at least in outflow direction, each flow path extends through the pores of the hollow-fibre membrane of one or more dialysers (120), wherein the connection piece has a condensate trap.

11. A method for purifying respiratory air, said method comprising passing the respiratory air through a haemodialysis dialyser .

12. A method for purifying respiratory air, said method comprising passing the respiratory air through the device of claim 1 .
